(19) United States
(12) Patent Application Publication
(10) Pub. No.: US 2009/0240558 A1
(43) Pub. Date: Sep. 24, 2009

(54) ENTERPRISE ANALYSIS AIDE AND ESTABLISHMENT OF CUSTOMIZED SALES SOLUTION

(76) Inventors: Kevin Bandy, Decatur, GA (US); Michelle Rees, Canton, GA (US)

Correspondence Address: Vedder Price PC, 222 NORTH LASALLE STREET, CHICAGO, IL, 60601, US

(21) Appl. No.: 12/052,289

(22) Filed: Mar. 20, 2008

(51) Int. Cl. G06Q 10/00

(52) U.S. Cl. 705/10

(57) ABSTRACT

An enterprise analysis aide is provided comprising four layers. The first layer comprises indicia of strategic considerations relevant to developing a sales strategy for the market. The second layer comprises indicia of sales channels to be used when defining an integrated resource alignment for the plurality of sales channels. The third layer comprises indicia of categorized operating capabilities that may be used to define standardized operating capabilities for sales. The fourth layer comprises indicia of data management operations to be considered when defining supportive data processing operations in furtherance of the sales strategy, integrated resource alignment and standardized operating capabilities. Because the enterprise analysis aide provides comprehensive vertical and horizontal integration, a customized sales solution may be developed for an enterprise in a more efficient and timely manner and result in solutions that are more naturally suited to the enterprise for which they are designed.

### FIELD OF THE INVENTION

The present invention relates generally to aides used in the analysis of business enterprises and, in particular, to an analysis aide for use in establishing a customized sales solution for an enterprise targeted to a specific market.

### BACKGROUND OF THE INVENTION

Many business organizations or enterprises are engaged in selling goods and/or services (collectively, “offerings”) to current and potential customers. In order to maintain growth, it is typically necessary to, among other things, develop new markets for the enterprise's offerings. As used herein, a market comprises any grouping or classification of potential buyers sharing one or more characteristics that permit establishing a specialized or tailored approach to selling to individual entities within the grouping or classification. It is often the case that an enterprise becomes adept at servicing one type of market but is otherwise unaccustomed to servicing another type of market. For example, large manufacturing companies may be accustomed to selling millions of units in a business-to-business environment, but may not have any experience in selling directly to consumers. Similarly, such companies may have difficulty applying existing sales programs to so-called small and medium-sized businesses (SMBs) due to the relatively fragmented nature of the SMB market. Despite these operational shortcomings, such markets may represent significant revenue potential to these companies. To be most effective at the task of selling to defined markets, an overall sales solution—i.e., an approach that integrates and manages operations between all sales-relevant layers and organizations within an enterprise to ensure optimal performance—is required.

Various providers are known in the art to provide services generally relating to development of various aspects of a sales solution including, for example, system integration, sales outsourcing, marketing, sales operations and technology deployment. A shortcoming, however, of such providers is that they do not connect capabilities (i.e., specific functions within the enterprise) to form an integrated and managed approach to developing sales solutions targeted to specific markets. That is, such service providers tend to be very narrow in their focus and, therefore, incapable of providing an integrated sales solution that satisfies the needs of all constituents within an enterprise involved with or otherwise affected by sales operations. Furthermore, even where consideration may be given to the full depth and breadth required when developing an effective sales solution, the actual implementation of such a solution typically fails to diagnose the strengths and weaknesses of an enterprise's current sales-related capabilities, and therefore fails to take advantage of such strengths or offer suggestions for improving the weaknesses.

Therefore, it would be advantageous to provide techniques for providing customized sales solutions for enterprises based on a holistic understanding of substantially all the capabilities necessary for establishing a comprehensive sales solution.

### SUMMARY OF THE INVENTION

The present invention provides a method and apparatus for establishing customized sales solutions targeting various markets. To this end, an enterprise analysis aide is provided comprising four layers. The first layer of the analysis aide comprises indicia of strategic considerations relevant to developing a sales strategy for the market. The second layer comprises indicia of sales channels to be used when defining an integrated resource alignment for the plurality of sales channels relevant to the market. The third layer comprises indicia of categorized operating capabilities that may be used to define standardized operating capabilities for sales. Finally, the fourth layer comprises indicia of data management operations to be considered when defining supportive data processing operations in furtherance of the sales strategy, integrated resource alignment and standardized operating capabilities. Although the enterprise analysis aide may be embodied in a variety of formats, in a presently preferred embodiment, the enterprise analysis aide may be generated using executable instructions that cause a processor to generate display data representative thereof. For example, the aide may be presented on a display of a suitably programmed computer or other processing device.

Using the enterprise analysis aide, in one embodiment of the present invention, operating capabilities as implemented by the enterprise may be compared against corresponding benchmarked operating capabilities defined in accordance with the categorized operating capabilities set forth in the analysis aide. The resulting comparison results may then be used to implement a customized sales solution that builds upon any existing operating capabilities and addresses any shortcomings or opportunities identified by the comparison results. As part of the comparison process, each of the benchmarked operating capabilities may be defined in terms of baseline, parity and leading characteristics thereby allowing a more detailed assessment and diagnosis of operating capabilities as implemented by the enterprise. Because the enterprise analysis aide of the present invention provides comprehensive vertical integration (from the most general strategic considerations to the most specific tactical or implementation-related considerations) and horizontal integration (across all aspects of sales-relevant enterprise capabilities), a customized sales solution may be developed for an enterprise by a single entity working in conjunction with the enterprise. In this manner, the present invention provides more efficient and timely development of customized sales solutions that are more naturally suited to the enterprise for which they are designed.

### BRIEF DESCRIPTION OF THE DRAWINGS

The features of the present invention are set forth with particularity in the appended claims. The invention itself, together with further features and attended advantages, will become apparent from consideration of the following detailed description, taken in conjunction with the accompanying drawings. One or more embodiments of the present invention are now described, by way of example only, with reference to the accompanied drawings wherein like reference numerals represent like elements and in which:

FIG. 1 is an illustration of an enterprise analysis aide in accordance with the present invention;

FIG. 2 is a more detailed illustration of one embodiment of an enterprise analysis aide in accordance with the present invention;

FIG. 3 is an even more detailed illustration of another embodiment of an enterprise analysis aide, particularly suited for use with SMB markets, in accordance with the present invention;

FIG. 4 is a flow chart illustrating processing in accordance with one embodiment of the present invention;

FIG. 5 is a flow chart illustrating processing in accordance with yet another embodiment of the present invention;

FIG. 6 is a block diagram illustrating an apparatus that may be used to implement an enterprise analysis aide in accordance with the present invention; and

FIG. 7 is a functional block diagram of an implementation of the controller and databases illustrated in FIG. 6.

### DETAILED DESCRIPTION OF THE PRESENT EMBODIMENTS

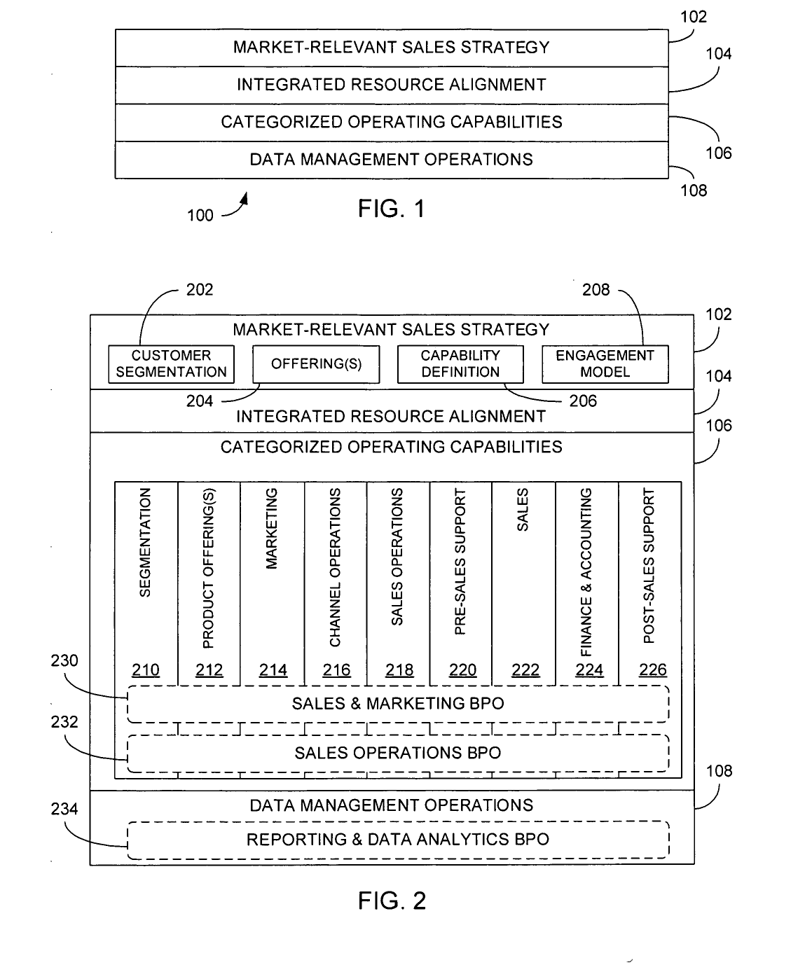

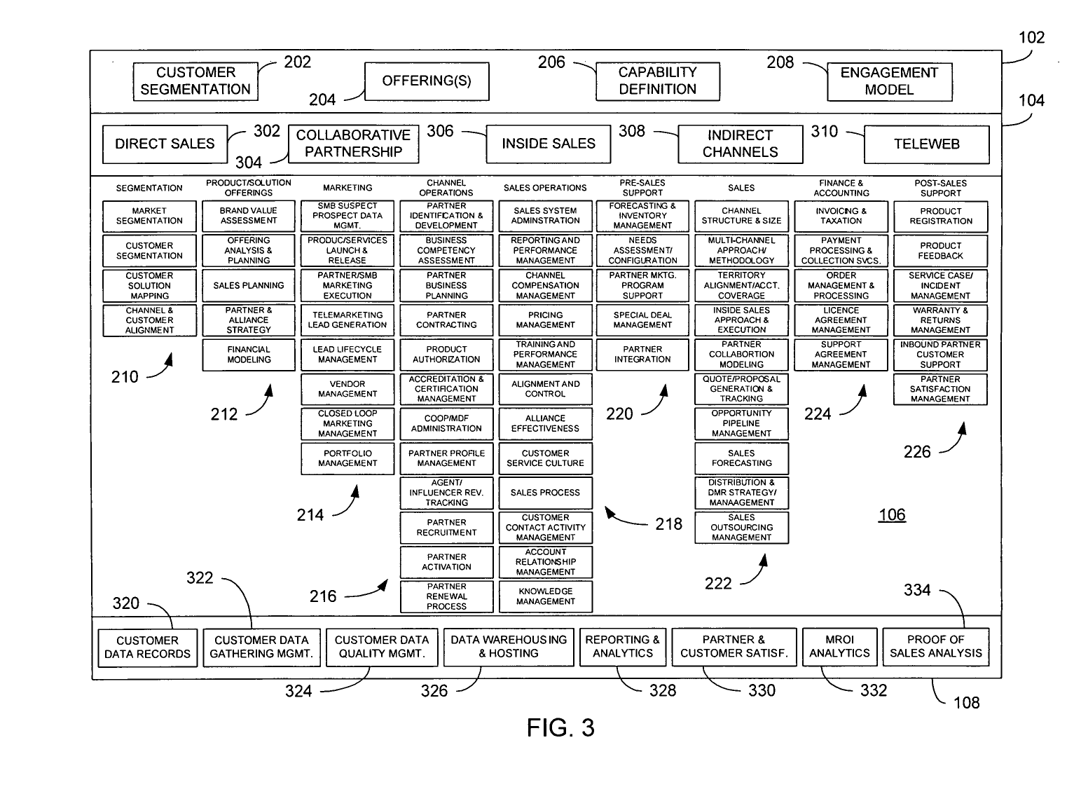

Referring now to FIG. 1, an enterprise analysis aide 100 is illustrated. As shown, the analysis aide 100 comprises a plurality of layers 102-108. As described in greater detail below, the layered structure of the analysis aide 100 provides a top-down, vertically integrated understanding necessary for the development of a customized sales solution for a targeted market, which understanding allows a single entity, working in conjunction with an enterprise, to successfully define and implement (or assist in implementing) the customized sales solution. Although various embodiments of the enterprise analysis aide in accordance with the present invention are illustrated below with particular reference to specific market types (particularly with regard to FIGS. 2 and 3), it is a feature of the present invention that the framework embodying the analysis aide 100 may be applied to a variety of market types.

In particular, the first layer 102 concerns the definition of a market-relevant sales strategy for the desired targeted market. As used herein, a sales strategy comprises an enterprise's goals for exploiting the targeted market and the general plans for achieving such goals. The second layer 104 concerns the definition of an integrated resource alignment across the plurality sales channels relevant to the market. In a most general sense, a sales channel constitutes a conduit (including any intervening parties, such as distributors, resellers, etc.) through which a vendor (i.e., the enterprise) communicates with and sells to the ultimate consumers of its offerings. Thus, an integrated resource alignment concerns identification of the best sales channels to support a sales strategy and those resources necessary for the implementation and management of such channels. A third layer 106 addresses categorized operating capabilities in furtherance of the sales strategy. As used herein, a capability comprises any function performed within an enterprise, preferably in support of or otherwise related to sales activities. As described in further detail below, the operating capabilities indicated in the third layer 106 are categorized across the full spectrum of activities that an enterprise should or could have available as part of its implementation of the sales solution. Finally, the fourth layer 108 concerns the development of data management operations in support of the upper three layers. That is, depending on the sales strategy developed and the integrated resource alignment and operational capabilities to be employed, the data management operations defined with the assistance of the fourth layer 108 are those required for effective execution in light thereof. As described in further detail below, an enterprise analysis aide in accordance with the present invention may be used to establish a customized sales solution targeting the market for a specific enterprise.

Referring now to FIG. 2, a more detailed illustration of an enterprise analysis aide in accordance with one embodiment of the present invention is provided. In particular, the analysis aide shown is specifically designed for establishing a customized sales solution relative to an SMB market. To this end, and with particular reference within the first layer 102, various indicia of strategic consideration 202-208 are shown. In particular, a customer segmentation indicator 202 is provided. The customer segmentation indicator 202 relates to developing an understanding of various groups of customers in the desired market, particularly those subsets of customers in the market that are most likely to purchase a given enterprise's offerings. A product/solution offerings indicator 204 is provided to address the need to understand the various offerings provided by the enterprise that are relevant to the desired market. A capability definition indicator 206 is provided and serves to develop an understanding of the necessary capabilities needed to properly implement and support a successful marketing strategy for the enterprise. Finally, as shown, an engagement model indicator 208 is also provided in furtherance of developing an appropriate model for approaching and working with customers within the desired market. Collectively, the indicia 202-208 of the first layer 102 illustrate the various considerations that must be factored into the development of a sales strategy. In this manner, the first layer 102 of the analysis aide may be used to focus efforts on developing the best sales strategy for a given enterprise. As noted above, and as described in further detail below, an integrated resource alignment concerning the plurality of sales channels may be defined using the second layer 104 based on the sales strategy defined based at least in part upon the indicia 202-208 in the first layer 102.

In support of the sales strategy developed in accordance with the first layer 102 and the integrated resource alignment developed in accordance with the second layer 104, the third layer 106 presents categorized operating capabilities for sales. In a presently preferred embodiment, the categorized operating capabilities may be arranged into a plurality of vertical groups 210-226 as shown. Generally, the entirety of the vertical groups 210-226 captures substantially the entire spectrum of possible activities within an enterprise that directly affect or are affected by sales. In this manner, the third layer 106 provides an integrated and comprehensive view of an enterprise's operating capabilities related to sales.

The particular groups illustrated in FIG. 2 are specifically designed for use in developing sales solutions in connections with SMB markets. To that end, a segmentation group 210 is illustrated and concerns those operating capabilities relating to understanding and developing customer segments relevant to the desired market. A product offerings grouping 212 concerns those operating capabilities necessary to define suitable products and/or services necessary to service the desired market. A marketing grouping 214 embraces activities that concern the marketing and advertising of the offerings of the enterprise. A channel operations grouping 216 addresses those channel operations that are necessary to support the integrated resource alignment designated via the second layer 104, particularly those activities relating to the management of sales channel partners. In a similar vein, a sales operations grouping 218 concerns processes may be performed by sales administrators or sales representatives that support sales as well as those operations necessary to support sales within the selected sales channels, including activities related to the assessment of such activities. A pre-sales support grouping 220 is provided and addresses those operations that support development of prospective sales opportunities. A sales grouping 222 addresses front-office sales execution capabilities. A finance and accounting grouping 224 addresses those activities within finance and accounting operations that are affected by or that have an effect upon the sales operations. Finally, a post-sales support grouping 226 is provided that concerns those activities within the enterprise addressing customer needs following completion of a sale. Note that the groupings illustrated in FIG. 2 are but one of any number of possible groupings that might be devised by those having ordinary skill in the art, and that the present invention is not limited in this regard.

FIG. 2 also illustrates opportunities for implementing at least a portion of the standardized operating capabilities by a single functional unit. For example, sales and marketing operating capabilities across the various groupings illustrated in FIG. 2 may be provided by a single sales and marketing business process outsource (BPO) 230. In a similar vein, a sales operation BPO 232 may also be provided comprising outsourced processes that are normally executed by sales representatives. As known in the art, such BPOs may be used to provide the cost-effective implementation of various operating capabilities across the various capabilities groupings thereby allowing an enterprise to focus on core-competencies necessary to continue development of the targeted market. By providing such cross-functional capabilities via a single functional unit (i.e., a single BPO provider), sales operations may be run in an efficient and cost-effective manner. As shown, the opportunities to provide services by a single functional unit likewise extend into the lower layers of the analysis aide, in particular the fourth layer 108 where reporting and data analytics may be encompassed by a single BPO 234. Although less preferable, those having skill in the art will appreciate that such BPOs can be deployed across less than the complete spectrum of operational capabilities for any given layer.

Referring now to FIG. 3, a more detailed depiction of an enterprise analysis aide in accordance with an embodiment of the present invention is provided. In particular, the illustration of FIG. 3 shows the various indicia of the second layer 104 in greater detail as well as the various indicia of the third and fourth layers 106, 108. With reference to the second layer 104, a direct sales indicator 302 is provided concerning a direct sales channel in which employees of the enterprise are engaged in directly dealing with the desired customers. A collaborative partnership indicator 304 is provided concerning the establishment and operation of partnerships with other enterprises that may be engaged in sales of products or services relating to the offerings of the enterprise. An inside sales channel indicator 306 is provided corresponding to operations in which sales are performed over the telephone as opposed to face-to-face. An indirect channels indicator 308 is provided concerning the use of distributors, resellers and the like. Finally, a teleweb channel indicator 310 is provided concerning the use of customer support call centers in conjunction with online customers seeking help from human personnel. Although each of the indicators 302-310 depicted in the second layer 104 represents a potential sales channel suitable for an SMP market, it will be appreciated by those having ordinary skill in the art that other specific indicators may be provided depending on the nature of the particular market being targeted.

Within the third layer 106, a plurality of categorized operating capabilities are shown within the vertical segments previously described. Once again, the categorized operating capabilities illustrated are exemplary in nature, particularly with regard to the SMB market, and could comprise other capabilities as a matter of design choice. It is also noted that capabilities do not necessarily reflect specific organizations or personnel groups within an enterprise although this is, of course, a possibility. Techniques for implementing such capabilities are known to those having skill in the art. Within the segmentation grouping 210, a Market Segmentation capability is shown concerning the ability to analyze the differences between markets, and apply the acquired insight in a structured manner to guide marketing activities and focus tailored marketing programs. A Customer Segmentation capability concerns database driven data analysis that groups customers with similar characteristics into logical segments and identifies segment attributes and profiles, thereby allowing targeted marketing efforts to drive greater business value from scarce marketing resources. A Customer Solution Mapping capability concerns the ability to apply understanding from market and customer analytics to identify the appropriate partner to work with, and how to take the offering to market. Finally, a Channel And Customer Alignment capability is provided concerning the ability to integrate an indirect channel model with customer needs/preferences to deliver offerings with a compelling value proposition.

Within the products/solution offerings grouping 212, a Brand Value Assessment capability is provided concerning the ability to provide a consistent, differentiated branded customer experience through all channels and partners, which reinforces a single company image, reflects the companies value proposition and creates value. An Offering Analysis And Planning capability concerns the ability to assess the potential of offerings to profitably meet business targets and objectives, then develop effective strategies for clients and their customers. A Sales Planning capability concerns the leveraging of all relevant information to balance activities across markets and customer segments to thereby maximize returns to the business and realize long-term value. A Partner And Alliance Strategy capability is provided concerning the ability to provide an end-to-end business solution through partnerships and alliances, and to create competitive advantages in incremental value for customers. Finally, a Financial Modeling capability is provided concerning the application of sophisticated financial modeling techniques to define pricing models, identify the most profitable sales channel mix and understand the impact of certain marketing actions on overall business value, thus informing business planning.

Within the marketing grouping 214, an SMB Suspect Prospect Data Management capability is provided concerning the ability to define what data is required to fulfill business objectives and to orchestrate activities to ensure data availability, quality and exploitation. A Price/Service Launch And Release capability is provided concerning the ability to manage all activities required to take a new product from concept to launch and release, maximizing the capabilities of vendors and partners. An SMB/Partner Marketing Execution capability is provided concerning the ability to help partners successfully execute segmented and tailored marketing programs and campaigns. A Telemarketing Lead Generation capability is provided concerning processes for the identification, scoring, ranking and categorizing of prospective customer leads. A Lead Life-Cycle Management capability is provided concerning processes for ensuring that sales leads are executed and followed up in an appropriate, disciplined and timely manner. A Vendor Management capability is provided concerning the processes of managing the right vendors, ensuring proper product and service delivery through all channels. A Closed-Loop Marketing Program Management capability is provided concerning the orchestration of all marketing activities to maximize brand value, focus marketing efforts in the area of greatest opportunity and to facilitate continuous improvement of marketing effectiveness. Finally, a Portfolio Management capability is provided concerning the ability to align global marketing resources to exploit growth opportunities.

Within the channel operations grouping 216, a Partner Identification And Development capability is provided concerning the ability to improve and maintain service delivery identifying, attracting and retaining the right partners. A Business Competency And Accreditation/Certification Management capability is provided concerning the management of a structured accreditation program, to build loyalty to the product and promote quality of service delivery. A Partner Business Planning capability is provided concerning the ability to provide a collaborative environment for initial and cyclical business planning between account managers and partner organizations. A Partner Recruitment And Contacting capability is provided concerning communication of partner value propositions such as partner programs and a vertical market opportunities. A Product Authorization capability is provided concerning the definition and provision of sales and technical knowledge and support infrastructure to business partners to sell products and solutions. A Cooperative Advertising/Marketing Development Fund Administration capability is provided concerning the provision of a comprehensive tool suite for creating and managing such marketing related funds. A Partner Profile Management capability is provided concerning the capture of partnering information. An Agent/Influencer Revenue Tracking capability is provided concerning the ability to track, measure, analyze and manage the revenue generated by agents and influencers. A Partner Recruitment capability is provided concerning the ability to target partners, turn qualified prospects into newly recruited partners, and to sell solutions through market research, segmentation, and coverage analysis. A Partner Activation capability is provided concerning the provision of tools to partners to enable them to immediately start creating value for the business. Finally, a Partner Renewal Process capability is provided for the re-engagement of partners based on the total value to the organization.

Within the sales operations grouping 218, a Sales System Administration capability is provided concerning the provision of a unified sales system architecture to allow consistency of activities, promotion of best practices, and delivery of rich data back to the business. A Reporting and Performance Management capability provides concerning the ability to track, measure, analyze and manage the impact of sales compensation on performance. A Channel Compensation Management capability is provided concerning the employee compensation strategy and structure and links to customer-centric key performance indicators. A Pricing Management capability is provided concerning the identification of economic objectives, channel behaviors and end user needs to sell through third party intermediaries. A Training and Performance Management capability is provided concerning the management of the learning process from creating product/services offering awareness to developing skills and competencies within the channel network. An Alignment and Control capability is provided concerning the roles and responsibilities, especially customer relationship management (CRM) activities, within the channel. An Alliance Effectiveness capability is provided concerning the effective management of third-party providers and other alliances to optimize sales and marketing activities and generate maximum value for the business. A Customer Service Culture capability is provided concerning the orientation of company culture and behaviors towards customer services and markets. A Sales Process capability concerns processes for the closed loop management of sales activity. A Customer Contact Activity Management capability is provided to enable the sales channels to document and manage customer or prospect contacts (either direct or electronic). An Account Relationship Management capability is provided concerning enablement of the sales channel to manage account relationships, including capturing, categorizing, communicating and lodging customer interactions. Finally, a Knowledge Management capability is provided concerning the enablement of communication of market intelligence within organizations and partner networks including the provision of processes and tools which support the sharing of key knowledge and best practices across the enterprise.

Within the pre-sales support grouping 220, a Forecasting and Inventory Management capability is provided concerning the ability to predict market demands for products and services, and align supply-side factors accordingly. A Needs Assessment/Configuration capability is provided concerning the enablement of partners to manage a sales process from needs assessment, solution offering through to court generation. A Partner Marketing Program Support capability is provided concerning the provision of focused support for marketing activities undertaken by their channel partners. A Special Deal Management capability is provided concerning the ability to accommodate and manage extraordinary deals to take advantage of specific business opportunities. Finally, a Partner Integration capability is provided concerning the ability to enhance interaction between all indirect channel members, x-channels (both direct and indirect) and administrative personnel to more effectively close business opportunities and serve customer needs.

Within the sales grouping 222, a Channel Structure and Size capability is provided concerning the ability to optimize and align partner and internal resources to maximize business value in the market. A Multi-Channel Approach Methodology capability is provided concerning the ability to communicate with customers through a combination of channels to maximize response/conversion rates while upholding the branded customer experience. A Territory Alignment/Account Coverage capability is provided concerning processes for balancing customer accounts, workload and potential across territories to maximize market coverage. An Inside Sales Approach and Execution capability is provided to manage and coordinate inside sales, including methods of customer interaction, performance management, and people motivation and reward. A Partner Collaboration Modeling capability is provided concerning assessment of partner efforts and results on a real time basis to improve return on investment (ROI). A Quote/Proposal Generation and Tracking capability is provided concerning the enablement of a sales channel to generate and track proposals, including automation, personalization, status tracking and best practices communications. An Opportunity Pipeline Management capability is provided concerning management of sales opportunities through the different stages of the pipeline as well as collaboration between the sales team. A Sales Forecasting capability is provided concerning the approach to sales forecasting, including frequency, responsibility, type of forecasting and integration with manufacturing forecasts. A Distribution and Direct Marketing Reseller (DMR) Strategy/Management capability is provided concerning the selection and management of preferred distributors or partners, definition of roles and policies and identification of cost to serve reduction opportunities. Finally, a Sales Outsourcing Management capability is provided concerning the ability to manage and measure activities of third-party providers of outsourced sales and sales support personnel.

Within the finance and accounting grouping 224, an Invoicing and Taxation capability is provided concerning effective procedures for handling invoicing and taxation consistently and correctly. A Payment Processing and Collection Services capability is provided concerning the use of collections activities as part of an account management process. An Order Management and Processing capability is provided concerning the processing of high order volume at minimal cost through building and maintaining accounts, products, and offers; enabling and influencing customers to place orders through the desired channels; and delivering order status through the right channels at the right time. A License Agreement Management capability is provided concerning the ability to sell and manage license agreements in a way that maximizes penetration and brand value in the desired market. Finally, a Support Agreement Management capability is provided concerning the ability to create and manage support agreements that meet client needs and promote brand loyalty in a cost effective manner.

Within the post-sales support grouping 226, a Product Registration capability is provided concerning the ability to work with customers through a range of channels to register products and also gather important information for future marketing use. A Product Feedback capability is provided concerning processes for capturing feedback about products and customers with a view to improving future products and releases. A Service Case/Incident Management capability is provided concerning the ability of partners to manage the service and support process from identification to resolution through the use of range of tools. A Warranty and Returns Management capability is provided concerning the development of after-sales support programs and tracking of planned versus actual cost of covered customer support. An Inbound Partner/Customer Support capability is provided concerning the verification of warranty entitlement, the resolution, direction, or escalation of customer service issues, or the up-sale of products and service to existing customers. Finally, a Partner and Customer Satisfaction Management capability is provided concerning management of relationships with partners and customer communities to gauge the satisfaction of partners worldwide.

As also shown in FIG. 3, the fourth layer 108 illustrates a plurality of data operations in support of the sales strategy, integrated resource alignment and standardized operating capabilities described above. Techniques for implementing such data operations are known to those having ordinary skill in the art. For example, as shown in FIG. 3, a customer data records capability 320 is provided concerning the provision of sufficient accurate information to inform marketing efforts and customer interactions, in order to build long lasting relationships with valued customers. A customer data gathering management capability 322 is provided concerning the collection of data from external sources (e.g., third-party vendors) and internal sources to enhance the customer/prospect database. A customer data quality management capability 324 is provided concerning the integration and management of customer identifiers and customer information across transaction (operational), interaction and analytical data warehouses. A data warehousing and hosting capability 326 is provided concerning the processing of data management within a data warehouse, including extract/transform/load functions, data hygiene, redundancy elimination, periodic data refreshers and maintenance updates. A reporting and analytics capability 328 is provided concerning performance of data exploration, querying and reporting on customers and prospects and operations. A partner and customer satisfaction capability 330 is provided concerning the ability of the organization to understand partners to make changes necessary to accommodate their needs and enhance loyalty. A marketing return on investment (MROI) analytics capability 332 is provided concerning the ability to measure the impact of specific activities, identify the drivers of value, and apply this knowledge to generate value in future marketing programs. Finally, a proof of sales analysis capability 334 is provided concerning the ability to accurately attribute sales to the correct party/partner with a view to correctly administering compensations.

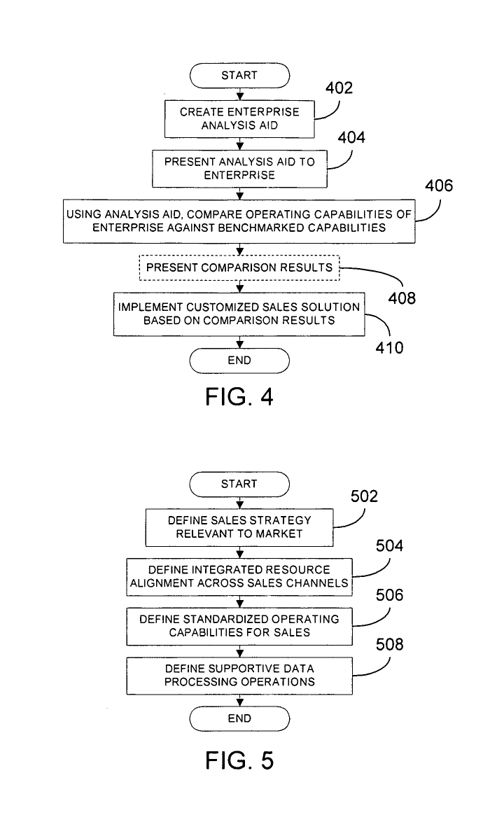

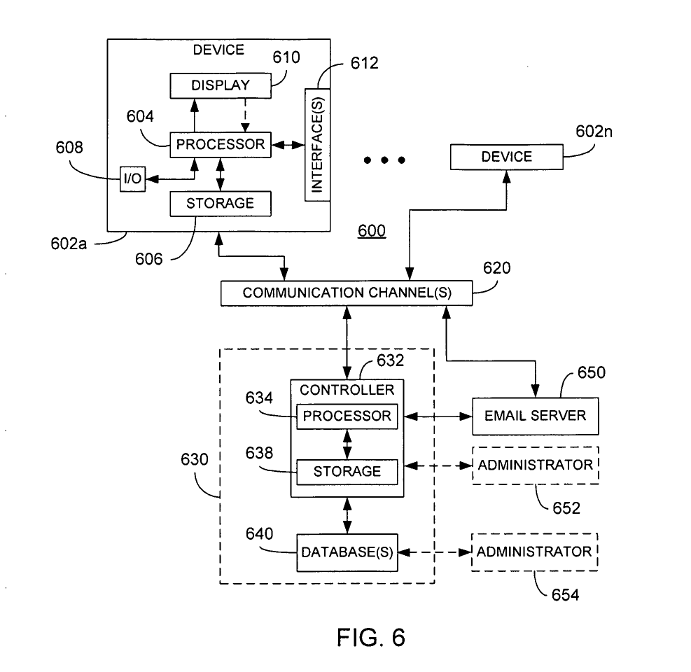

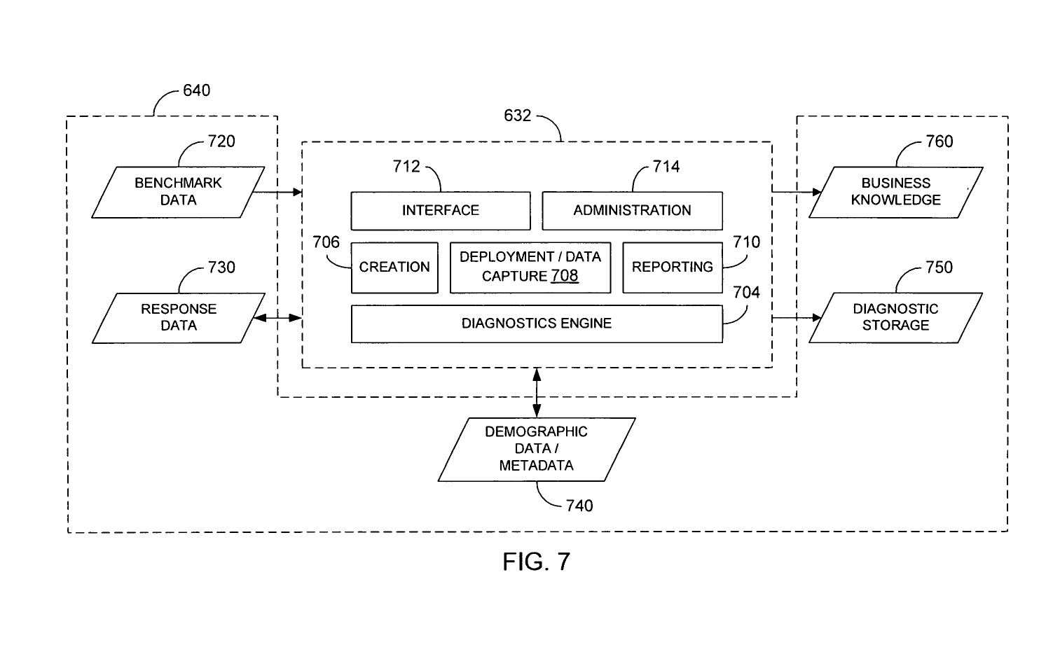

Referring now to FIG. 4, processing in accordance with the present invention is further illustrated. In particular, the process shown in FIG. 4 illustrates use of an enterprise analysis aid in accordance with the present invention in establishing a customized sales solution. Thus, at block 402, an enterprise analysis aide in accordance with the present invention, as described above, is created based on a targeted market. Thereafter, at block 404, the analysis aide created is presented to an enterprise as part of the establishment of the customized sales solution. In general, the presentation of the analysis aide may be accomplished in any manner that renders the various indicia included in the analysis aide perceptible. However, in a presently preferred embodiment, the analysis aide is created and rendered perceptible using a processing device comprising or otherwise in communication with a suitable display. Such an implementation is described below relative to FIGS. 6 and 7.

Regardless of the manner in which the analysis aide is presented, and referring once again to FIG. 4, processing continues at block 406 where, based on the analysis aide, a comparison of operating capabilities of the enterprise is performed against benchmarked capabilities as set forth in the enterprise analysis aide. That is, in a presently preferred embodiment, each of the categorized operating capabilities (various examples of which are described above) found within the third layer 106 are described in terms of various characteristics representative of the how such capabilities are carried out. More preferably, various characteristics that describe each capability may be distinguished in terms of baseline, parity and leading characteristics. Baseline characteristics represent the minimal characteristics that any enterprise would need to do to implement the capability, whereas parity characteristics are representative of what other enterprises typically do. In contrast, leading characteristics are best practices, as determined by surveys or reviews of other enterprises (i.e., benchmarked), in terms of implementing the corresponding capability.

By comparing the benchmarked capabilities characteristics with operating capabilities as implemented by a given enterprise (if at all), it is possible to identify which characteristics, for each capability, the enterprise is currently adhering to and which it could improve upon, i.e., where there are gaps in the necessary operating capabilities and where improvement opportunities exist. These comparison results may be optionally presented to the enterprise, as illustrated by block 408, in furtherance of identifying such gaps and improvement opportunities. For example, using formats known in the art, the comparison results may be presented as graphs or charts illustrating where the enterprise's implementation of each capability falls within the spectrum of baseline/parity/leading described above.

Regardless, processing thereafter continues at block 410 where the customized sales solution is implemented based on the comparison results. That is, the comparison results facilitate the identification of potential areas for sales and marketing improvement and improved alignment of strategy, resources, and capabilities therewith. Such improvements may be realized in terms of enhanced growth or improved efficiency or both.

Referring now to FIG. 5, further processing in accordance with the present invention is illustrated. In particular, the processing of FIG. 5 illustrates in greater detail the use of an enterprise analysis aide in accordance with the present invention. At block 502, a sales strategy relevant to a targeted market is defined by an entity working in conjunction with the enterprise. As used herein, an entity that works with the enterprise may comprise a single organization that advises the enterprise and, preferably, that is capable of implementing the desired customized sales solution (e.g., analysts, consultants, etc.). In devising the sales strategy, the entity attempts to ascertain the enterprise's goals for the desired sales solution and, keyed off of the considerations indicated in the analysis aide, derives plans for achieving those goals. Thereafter, at block 504, an integrated resource alignment across the plurality of sales channels relevant to the market is defined. As noted previously, this involves considering the different potential sales channels indicated in the analysis aide as being particularly relevant to the targeted market in light of the sales strategy defined previously. In this manner, the resulting selection of an integrated resource alignment across the potential sales channels is not solely based on an advising entity's ability to deliver a narrow solution in one or more of the potential channels, but rather takes into account the entire enterprise's goals as defined by the sale strategy.

Continuing at block 506, standardized operating capabilities for sales are defined. As noted above, particularly with reference to FIG. 4, this involves performing a diagnosis of the entity's existing operating capabilities through a comparison with benchmarked practices. The resulting comparison results allow the identification of any capabilities gaps and/or improvement opportunities, particularly in light of the selected sales channels designated in accordance with the integrated resource alignment. That is, any necessary changes to the operating capabilities are selected to directly support the necessary sales channels. Because this is done on the basis of the needs of the entire enterprise, rather than just a narrow portion of the enterprise's constituents (e.g., the marketing department, the accounting department, etc.), the deployment of operational capabilities is better integrated into the organization resulting in smoother and more efficient operations. Finally, at block 508, supportive data processing operations are defined in furtherance of the sales strategy, integrated resource alignment and standardized operating capabilities described above. For example, data processing operations that more directly integrate customer information into the various operational capabilities may be necessary to adequately support the selected sales channels. In practice, the definition of appropriate data processing operations may include the recommendation, configuration and deployment of appropriate processes, hardware and software systems and training therefore as needed. In total, resulting the sales strategy, integrated resource alignment, standardized operating capabilities and supportive data processing operations establish the customized sales solution.

As noted above, the development and use of an enterprise analysis aide as described herein may be facilitated using one or more processing devices and systems comprising such devices. Such implementations are further described with reference to FIGS. 6 and 7. Referring now to FIG. 6, a system 600 that may be used to implement various aspects of the present invention is further illustrated. In particular, the system 600 preferably comprises one or more processing devices 602 having a processor 604, storage 606, a display 610, input/output components 608 and one or more interfaces 612 as illustrated. For example, the processing device 602 may comprise a desk-top, lap-top or hand-held computer, a personal digital assistant (PDA), a wireless communication device or equivalent devices as known to those having skill in the art. The processor 604 may comprise any component capable of executing stored instructions and operating upon stored data such as a microprocessor, microcontroller, digital signal processor, graphics co-processor or similar devices or combinations thereof. Alternatively, the processor 604 may comprise a hardware equivalent such as a programmable logic array, application specific circuit (ASIC) or similar components known to those of skill in the art. The storage 606 may comprise any machine-readable medium capable of operating in conjunction with the processor 604. Preferably, the storage 606 comprises any combination of volatile or non-volatile memory such as random access memory (RAM), read-only memory (ROM), electrically erasable programmable read only memory (EEPROM), etc. Generally, the storage 606 may comprise executable instructions for use by the processor 604 and may comprise storage locations for storage of display data (in addition to other data operated upon during implementation of the various embodiments described herein) to be rendered on the display 610.

The display 610 may be integral to the apparatus 600 as in the case, for example, of a laptop computer or personal digital assistant LCD display, and/or may optionally comprise an external display device such as an external monitor or projector. Techniques for providing display data to a display using a processor and stored, executable instructions are well known in the art. Similarly, techniques for generating display data, such as display data that is representative of an analysis aide in accordance with the present invention, are also well known. Input/output components 608, other than the display 610, may also be provided, e.g., a keyboard, a mouse and cursor arrangement, serial or parallel input ports, removable storage media, etc. In one embodiment of the present invention, display data representative of the analysis aide is provided to the display as part of a graphical user interface (including, for example, a user input device such as a mouse and cursor) whereby a user of the apparatus 600 is able to interact with the apparatus 600 via the graphical user interface. In this case, the display 610 may comprise a touch screen thereby allowing user input signals (illustrated as dashed line from the display 610 to the processor 604) to be received. Once again, techniques for implementing such graphical user interfaces are known in the art. Finally, the one or more interfaces 612 may comprise any necessary software/firmware/hardware used to terminate communication protocols supported by the device 602 such as, but not limited to, wired network protocols, wireless protocols, etc. In this manner, each device 602 may communicate with other devices, including a controller 632 as shown, via one or more intervening communication channels 620. The communication channel(s) may comprises any combination of public or private networks including, but not limited to, private networks such as local area networks (LANs), public networks such as the Internet or World Wide Web, or wireless networks.

In one embodiment, any of the processing devices 602 may be used to implement the processing of block 402 and, more particularly, block 404. For example, a first processing device 602a may be used develop the enterprise analysis aide and thereafter used to present the analysis aide to the enterprise. As used here, “presentation” of the analysis aide encompasses both visual depiction of the aide as well as its use for facilitating discussion between analysts and enterprise personnel, i.e., for use by a consultant working with the enterprise's personnel. In an alternative embodiment, a remote embodiment is provided. For example, as further shown in FIG. 6, a controller 632 in communication with one or more databases 640 may be provided. In an embodiment, the controller 632 comprises one or more server computers implementing suitable web server software capable of serving web pages to requesting entities. As known in the art, the controller 632 comprises one or more processors 634 in communication with at least one storage component 638 that stores instructions used by the processor(s) to implement at least portions of the functionality described herein. In a similar vein, the database(s) 640 may comprise one or more server computers implementing suitable database software. While a particular implementation of the controller 632 is illustrated in FIG. 6, those having ordinary skill in the art will appreciate that any suitable combination of software and hardware components may be used for this purpose. For example, dedicated hardware components, such as ASICs, programmable logic arrays, state machines, etc. may be equally employed as a matter of design choice.

In one embodiment, the controller 632 and database(s) 640, using known techniques, exist within a highly protected computing environment 630 and communicate with each other using security protocols that are transparent to outside entities. Nevertheless, secured communication links between the controller 632 and/or database(s) 640 may be provided (via computer-implemented terminals not shown) for use by one or more administrators 652, 654. For example, a first administrator 652 with relatively limited access may be allowed to access the controller 634 (web server) to handle project management duties such as ensuring input of appropriate personnel data, causing any required email communications to be undertaken, requesting specific analyses and reports, etc. Further still, a second administrator 654, preferably experienced in the construction of enterprise analysis aides as described herein, may be granted access to the database(s) 640 (in addition to the controller 632) for the purpose, for example, of creating/modifying enterprise analysis aides, statistical programming, creating and editing report schemas, maintaining and updated business rules and functions, etc.

Finally, an email server 650, as known in the art, is provided to allow the controller 632 to communicate with the various terminals 602 using email. For example, this capability may be used to send notification emails to various enterprise personnel requesting that they participate in the use of the enterprise analysis aide and providing them instructions concerning how to access the controller 632 for this purpose.

Referring now to FIG. 7, an example of a functional implementation of the controller 632 and database(s) 640 is illustrated. As shown, the controller 632 comprises a plurality of hierarchically arranged functional components 704-714. At the lowest level, a diagnostics engine 704 is provided implementing the basic data processing routines used by the controller 632. Preferably implemented using software programming techniques, implementation of such data processing routines is well known to those of skill in the art. Based on the capabilities of the diagnostics engine 704, a creation component 706, a deployment/data capture component 708 and a reporting component 710 are provided. Once again, techniques for implementing such components, particularly using software programming techniques, are well known in the art. The creation component provides the necessary functions to configure an enterprise analysis aide as described above. For example, based on user inputs received via the interface component 712, the creation component 706 allows an enterprise analysis aide to be configured to best match the needs of a given enterprise. Once the enterprise analysis aide has been defined, the deployment/data capture component 708 operates to capture data representative of the operating capabilities of the enterprise based on the enterprise analysis aide. For example, in one embodiment, the deployment/data capture component 708 may cause questions based on the enterprise analysis aide to be presented to various personnel within the enterprise in the form of a survey questionnaire. In this case, the enterprise personnel may be invited to participate in the survey via requests sent by the email server 650. Alternatively, where on-site, face to face interviews of enterprise personnel are employed, the deployment/data capture component 708 may simply cause the enterprise analysis aide to be presented to the on-site analyst/consultant whom may then manually gather the data.

Regardless of the manner in which the data representative of the operating capabilities of the enterprise is gathered, the reporting component 710 provides the desired comparisons of the enterprise's operating capabilities against benchmark data, as described above. Once again, any of a number of well known graphical and/or textual techniques may be provided in the reports generated by the reporting component 710. For example, metrics illustrative of the various operational capabilities of the enterprise (optionally broken down according any of a variety of characteristics, such as business unit, region, personnel, technology, etc.) may be depicted in bar graph or textual form, including optional comparison with corresponding benchmarks.

At the uppermost level, an interface component 712 and administration component 714 are provided. As noted above, the interface component 712 provide a user interface, preferably a graphical user interface, that allows an authorized user to perform the necessary operations in developing and deploying an enterprise analysis aide, e.g., configuring/modifying the enterprise analysis aide, managing information about the selected respondents within the enterprise, producing desired reports/charts, etc. The administration component 714 provides an interface for handling various administrative tasks such as configuring the controller (e.g., designating authorized users, access modes, etc.), updating profile information and updating or adding content to be presented via the user interface 712. Although the interface component 712 and administration component 714 may be accessed directly by administrators 652, 654 as described above, it is also anticipated that these components may be used remotely using, for example, a client/server arrangement. In this manner, a remote device 602 may be used develop and/or deploy an enterprise analysis aide.

FIG. 7 also illustrates various components of the database(s) 640. For example, benchmark data 720 may be stored in the database(s) 640. Preferably, the benchmark data 720 may comprise structured data that can be linked to the controller 632 tool for purposes of benchmarking, reporting and analysis as described above. Such benchmark data is well known in the art and may be obtained commercially (e.g., via providers such as the Hackett Group) or through development of proprietary databases. Response data 730 comprises the data received from enterprise personnel when responding to survey questionnaires as described above. In support of gathering such data, the demographic data/metadata 740 comprises user profile data, respondent data, survey questionnaire data, etc. Additional content may include frequently asked questions and answers, guidelines for using the controller 632, etc. The diagnostics storage 750 operates to store all analysis data and results gathered/provided by the controller 632, and the business knowledge 760 encompasses packaged reports and anonymous results that may be used for other business purposes.

As described above, the present invention provides a method and apparatus for establishing customized sales solutions targeting various markets. This is achieved through the use of an enterprise analysis aide that, by its design, allows an entity advising an enterprise to design a customized sales solution based on a holistic view of the enterprise, rather than a more narrow view as is typically the case using prior art techniques. In one aspect of the present invention, optimized deployment of enterprise-wide operational capabilities is provided through comparison of existing practices with benchmarked capabilities. For at least these reasons, the present invention represents an advancement over prior art techniques.

While the particular preferred embodiments of the present invention have been shown and described, it will be obvious to those skilled in the art that changes and modifications may be made without departing from the teachings of the invention. It is therefore contemplated that the present invention cover any and all modifications, variations or equivalents that fall within the scope of the basic underlying principles disclosed above and claimed herein.

What is claimed is:

1. A method for establishing, for an enterprise, a customized sales solution targeting a market, comprising:
defining, by an entity in conjunction with the enterprise, a sales strategy relevant to the market;
defining, by the entity in conjunction with the enterprise, an integrated resource alignment across a plurality of sales channels relevant to the market;
defining, by the entity in conjunction with the enterprise, standardized operating capabilities for sales; and
defining, by the entity in conjunction with the enterprise, supportive data processing operations in furtherance of the sales strategy, integrated resource alignment and standardized operating capabilities, the customized sales solution comprising the sales strategy, integrated resource alignment, standardized operating capabilities and supportive data processing operations.

2. The method of claim 1, further comprising:
presenting, by the entity to the enterprise, an enterprise analysis aid supporting the method.

3. The method of claim 2, wherein the enterprise analysis aid comprises:
a first layer comprising indicia of strategic considerations to be considered when defining the sales strategy;
a second layer comprising indicia of sales channels to be considered when defining the integrated resource alignment;
a third layer comprising indicia of categorized operating capabilities to be considered when defining the standardized operating capabilities; and
a fourth layer comprising indicia of data management operations to be considered when defining the supportive data processing operations.

4. The method of claim 3, wherein the indicia of categorized operating capabilities are arranged in groups concerning at least one of: segmentation, product/solution offerings, marketing, channel operations, sales operations, pre-sales support, sales finance/accounting, and post-sales support.

5. The method of claim 1, wherein at least a portion of the standardized operating capabilities are delivered by a single functional unit.

6. The method of claim 1, wherein defining the sales strategy further comprises analyzing at least one of: a plurality of customer segments, at least one offering, required market delivery capabilities and an engagement model.

7. The method of claim 1, wherein defining the integrated resource alignment further comprises analyzing possible usage of at least one of: a direct sales channel, a collaborative partnership channel, an inside sales channel, an indirect sales channel and a teleweb channel.

8. The method of claim 1, wherein defining standardized operating procedures further comprises comparing each of a plurality of operating capabilities as implemented by the enterprise against corresponding benchmarked operating capabilities to provide comparison results.

9. The method of claim 8, wherein assessing each of the plurality of operating capabilities further comprises comparing each of the plurality of operating capabilities against at least one of: baseline characteristics, parity characteristics and leading characteristics.

10. The method of claim 8, further comprising:
presenting the comparison results to the enterprise.

11. The method of claim 8, further comprising:
identifying at least one of operating capabilities gaps and operating capabilities improvement opportunities based on the comparison results,
wherein the standardized operating capabilities are based in part upon either of the operating capabilities gaps and the operating capabilities improvement opportunities.

12. An enterprise analysis aid for use by an entity in establishing, for an enterprise, a customized sales solution targeting a market, comprising:
a first layer comprising indicia of strategic considerations to be considered when defining a sales strategy relevant to the market;
a second layer comprising indicia of sales channels to be considered when defining an integrated resource alignment across a plurality of sales channels relevant to the market;
a third layer comprising indicia of categorized operating capabilities to be considered when defining standardized operating capabilities for sales; and
a fourth layer comprising indicia of data management operations to be considered when defining supportive data processing operations in furtherance of the sales strategy, integrated resource alignment and standardized operating capabilities.

13. A machine-readable medium having stored thereon executable instructions that, when executed by a processor, cause the processor to generate display data representative of the enterprise analysis aid of claim 12.

14. A machine-readable medium having stored thereon display data representative of the enterprise analysis aid of claim 12.

15. In a device comprising a processor in communication with a display, a method for providing a graphical user interface, comprising:
generating, by the processor, display data representative of the enterprise analysis aid of claim 12; and
providing, by the processor, the display data to the display.

16. The enterprise analysis aid of claim 12, wherein the indicia of strategic considerations further comprises indicia corresponding to at least one of: customer segments, product offerings, required market delivery capabilities and an engagement model.

17. The enterprise analysis aid of claim 12, wherein the indicia of sales channels further comprises indicia corresponding to at least one of: a direct sales channel, a collaborative partnership channel, an inside sales channel, an indirect sales channel and a teleweb channel.

18. The enterprise analysis aid of claim 12, wherein the indicia of categorized operating capabilities are arranged in groups concerning at least one of: segmentation, product/solution offerings, marketing, channel operations, sales operations, pre-sales support, sales finance/accounting, and post-sales support.

19. A method for establishing, for an enterprise, a customized sales solution targeting a market, comprising:
creating an enterprise analysis aid customized to the market, the enterprise analysis aid comprising:
a first layer comprising indicia of strategic considerations to be considered when defining a sales strategy relevant to the market;
a second layer comprising indicia of sales channels to be considered when defining an integrated resource alignment across a plurality of sales channels relevant to the market;
a third layer comprising indicia of categorized operating capabilities to be considered when defining standardized operating capabilities for sales; and
a fourth layer comprising indicia of data management operations to be considered when defining supportive data processing operations in furtherance of the sales strategy, integrated resource alignment and standardized operating capabilities;
comparing each of the categorized operating capabilities as implemented by the enterprise against corresponding benchmarked operating capabilities to provide comparison results; and
implementing the customized sales solution based at least in part upon the comparison results.

20. A system used to implement the customized sales solution established in accordance with the method of claim 19.

21. The system of claim 20, wherein the system comprises a computer-implemented system.
